(19) United States
(12) Patent Application Publication
(10) Pub. No.: US 2007/0050482 A1
(43) Pub. Date: Mar. 1, 2007

(54) System and method for executing web pages using a multi-tiered distributed framework

(75) Inventors: Johan A.F. Sundstrom, Kirkland, WA (US); David A.W. Snelling, Everett, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/209,440

(22) Filed: Aug. 23, 2005

(51) Int. Cl. G06F 15/177

(52) U.S. Cl. 709/220

(57) ABSTRACT

A system and method for rendering pages, and a configuration server are disclosed. The system comprises at least one rendering server, at least one composition service server, and a configuration server. The method comprises receiving a request to render, checking cache for a web service, requesting the web service, and rendering. The configuration server comprises a storage module and a transmit module.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention generally relates to rendering Internet web pages. More specifically, the present invention relates to improving the reliability and efficiency of web sites operating on multiple computer servers.

### BACKGROUND OF THE INVENTION

The Internet allows users to link to a network of computers and exchange information through viewable websites. A website consists of individual sets of web pages that can be visited using a web browser. Two forms of websites exist: disk-based sites and server-based websites. Disk-based sites can be run on any kind of computer, floppy disk, CD-ROM, or other computer-readable medium. Server-based sites run on a web server, which is a computer specifically configured to host websites and run software enabling it to answer requests for documents and other data. Most websites are initially developed as disk-based sites, then published to a web server either within the publisher's organization or to a remote location. Typically, the entire website is stored on an individual web server.

In the networking world, web services are used by computers to run web-based applications located on the same network. Web services use a typical client/server relationship between network devices and include such functions, for example, as Google's Map Service, Map Point, and Internet calendars. Web service functions are provided over the Internet, which presents a number of challenges for those on a private network. In a private network, servers and clients can be tailored to use any protocol or network architecture to eliminate external problems such as network latency, low bandwidth, and network outages. In contrast, the Internet is a heterogeneous environment made up of a wide variety of network architectures, where almost every type of Internet device in existence is trying to send and receive data. For a web service to be useful, it must be able to communicate with as many disparate systems as possible.

Today, many large scale websites are server-based and consist of numerous pages of data containing a myriad of web services. Such sites are typically run on large servers necessitating multiple server boxes for additional storage capacity. Typically, each server is configured to perform all aspects of web page hosting, namely rendering, web service storage and implementation, and configuration. Currently, existing web technologies do not provide a way of scaling out web-page rendering in a service-oriented, distributed fashion so that each individual component can be scaled separately. In addition, running multiple components side by side on front-end servers can present scalability and reliability issues. The addition of new functionality also makes website stability difficult to predict. Furthermore, some web services need to be isolated from others in order to maintain system stability and reliability; otherwise, one malfunctioning control or web service could bring down a server or entire site. For example, new web services may cause unforeseen code interaction or resource contention between memory systems, CPUs, etc. Moreover, different people in various groups may have written each web services' language. Differing languages, variables, and other integration parameters may frustrate access to web services because the services themselves are comprised differently. Therefore, a need exists for a more efficient way to store, manage, and render websites, as well as locate and access web services quickly.

### SUMMARY OF THE INVENTION

In the present invention, a centrally configured, distributed service-oriented framework assembles web pages from content fragments. The framework calls web services to generate page content and caches the results for quick reuse. This is performed by separating website hosting into three parts: configuration, rendering, and composition services. The configuration tier centrally manages the rendering and composition service tiers by providing configuration, location, and parameter information of individual services and servers to both tiers. The rendering tier calls web services and stores their responses in cache for quick access and reuse. The composition service tier, houses web services and provides their location to the configuration tier. Placing rendering, composition services, and configuration into different tiers reduces resource contention on the rendering tier while providing isolation and guarding against broken web services causing a website to crash.

### BRIEF DESCRIPTION OF THE SEVERAL VIEWS OF THE DRAWINGS

The present invention is described in detail below with reference to the attached drawing figures, which are incorporated by reference herein and wherein:

FIG. 1 is a block diagram of a computing system environment suitable for use in implementing the present invention;

FIG. 2 is a flow diagram of a multi-tiered system for rendering web pages, according to embodiments of the present invention;

FIG. 3 is a block diagram of a multi-tiered system for rendering web pages, according to embodiments of the present invention;

FIG. 4 is a flowchart illustrating a process for rendering a web page, according to embodiments of the present invention;

FIG. 5 is a flowchart illustrating web service caching, according to embodiments of the present invention;

FIG. 6 is a flowchart illustrating cache buffering, according to embodiments of the present invention; and

FIG. 7 is a flowchart illustrating the management of updates, according to embodiments of the present invention.

### DETAILED DESCRIPTION OF THE INVENTION

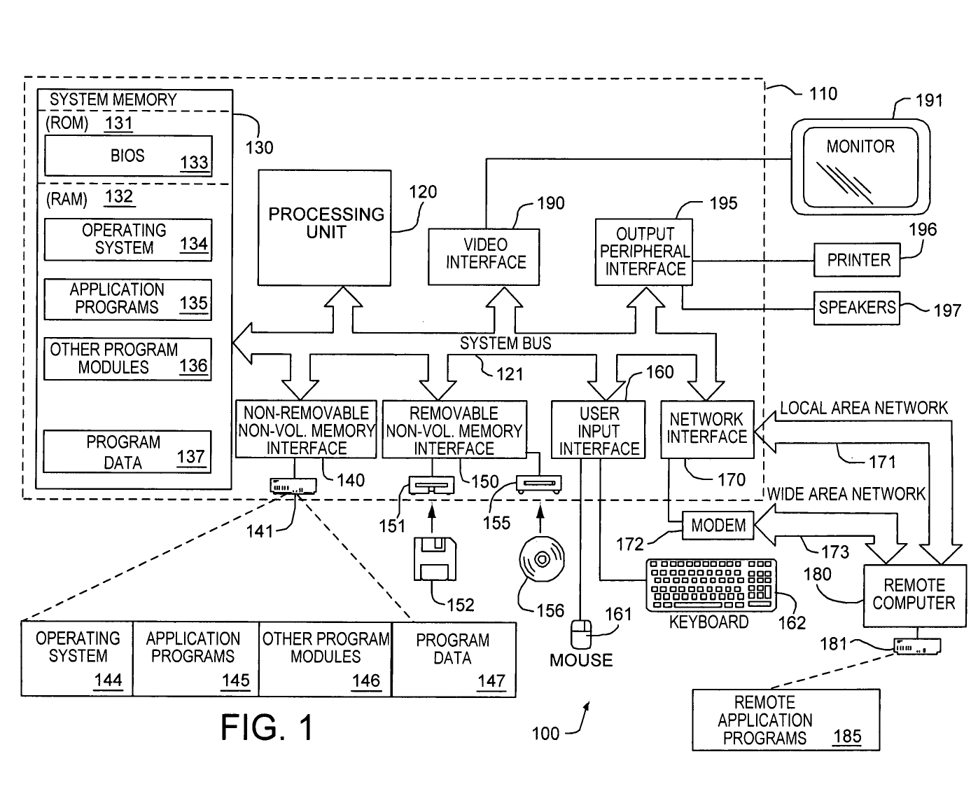

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (“ISA”) bus, Micro Channel Architecture (MCA) bus, Enhanced ISA (EISA) bus, Video Interconnect (“PCI”) bus also know as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable medial may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (“DVD”) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (“ROM”) 131 and random access memory (RAM) 132. A basic input/output system 133 (“BIOS”), containing the basic routines that help to transfer information between elements within computer 110, such as during start-up, is typically stored in ROM 131. RAM 132 typically contains data and/or program modules that are immediately accessible to and/or presently begin operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drive and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different number here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (“LAN”) 171 and a wide area network (“WAN”) 173, but may also include other networks. Such networking environments are commonplace in offices, enterprise-wide computer networks, intranets and Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user network interface 170, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

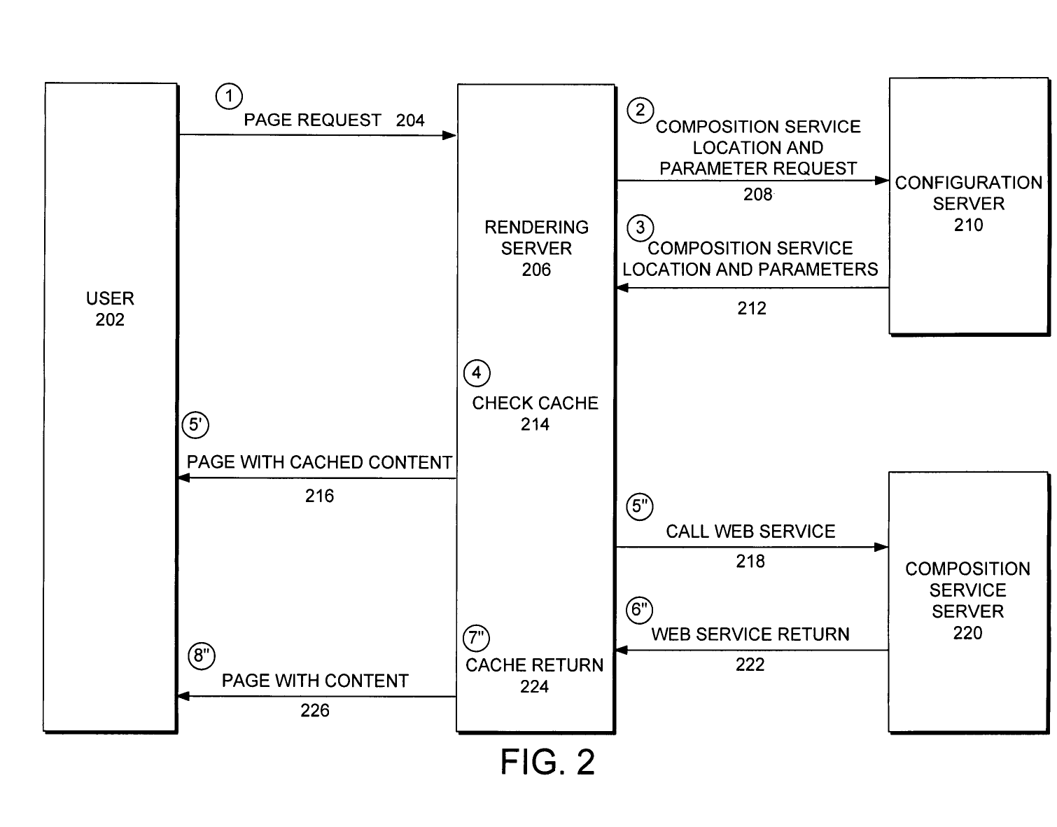

FIG. 2 is a flow diagram of a multi-tiered system for rendering web pages, according to embodiments of the present invention. In FIG. 2, user 202, who can be any user on the World Wide Web, is trying to access a web page. Rendering server 206 renders the page by executing controls, checking its cache, and requesting web services from composition service server 220. Configuration server 210 provides rendering sever 206 with information to locate appropriate web services. Composition service server 220 stores web services and provides configuration service 210 with web service parameters and location information. Furthermore, rendering server 206, configuration server 210, and composition service server 220 are not limited by any specific software running on the server. In various embodiments, each server may run Apache, Microsoft® Internet Information Server (“IIS”), National Center for Supercomputing Applications (“NCSA”), Sun, or other server software. Rendering server 206, configuration server 210, and composition service server 220 are not limited to any particular type of server configuration. Moreover, in an embodiment, rendering server 206 and composition service server 220 may comprise multiple servers, and in an embodiment, could be housed in multiple server boxes. Configuration server 210, on the other hand, is comprised of a single server. In an embodiment, though, configuration server 210 may be housed in multiple server boxes.

In an embodiment, web services are application components accessible over open protocols. More specifically, web services can be site-specific or global services used to return content fragments that in turn are used when assembling a web page for user 202. In an embodiment, a control is any piece of code executed on a web page. In an embodiment, web services are functions or sets of functions that can be accessed from another computer or network device to obtain portions of a web page. Other embodiments of web services may contain ASP or ASP.NET tags. Examples of actual web services include Google's Map Service, Map Point, or other functions requiring returned from a declarative call to another computer.

Content fragments are the portions of a web page returned by executed controls or web services. In general, fragments include nearly all data used to display a web page. For example, if a web page displays traffic conditions for a particular city, a construction notice for Oak road and a map of the city would both be fragments. In another embodiment, HTTP headers are also fragments. For example, cookies to manage state, content expiration to manage internet proxy caching, or 302 redirect directives are all considered fragments. In another embodiment, the content fragments can be in any Multipurpose Internet Mail Extensions (“MIME”) type, such as HTML, XML, JavaScript, JPG, binary format, etc. In another embodiment, web services may use Extensible Markup Language (“XML”), Simple Object Access Protocol (“SOAP”), Web Services Description Language (“WSDL”), Universal Description Discovery and Integration (“UDDI”), or any other open standard over an Internet protocol backbone to provide a way of integrating web-based applications. Embodiments of the present invention, however, are not limited to one standard. For example, in an embodiment, XML could be used to tag the data, SOAP could be used to transfer the data, WSDL could be used for describing the services available, and UDDI could be used for listing what services are available.

As illustrated in FIG. 2, user 202 submits a page request (204) to access a web page to rendering server 206. In an embodiment of the present invention, rendering server 206 is a dedicated server that is responsible for assembling a web page from a plurality of fragments. In another embodiment, rendering server 206 is embedded on a web page, downloaded, and executed. For example, a JavaScript code library or ActiveX control could allow access to rendering server 206. In yet another embodiment, rendering server 206 is embedded in an application. The composing mechanics of gathering the fragments and displaying them to the user is not limited to a dedicated server. For example, any computer running server software, such as a laptop, may function as rendering server 206. After receiving user 202's page request, rendering server 206 identifies and prioritizes all of the web page controls into phases (discussed below) in order to execute them one at a time. As mentioned previously, in an embodiment, a control is any piece of code executed on a web page. For example, a submit button, order form, or membership login constitute controls. For each control, rendering server 206 determines whether the control's response is in rendering server 206's cache. For controls rendering server 206 does not have stored in its cache, rendering server 206 calls a web service. To call a web service, in an embodiment, rendering server 206, which is in communication with configuration server 210, requests the parameter and location information for a web service (208) from configuration server 210. In an embodiment, parameter information comprises specific variants by which a web service return can differ, and location information comprises the web service's actual location. For example, suppose a web service is called to locate all African elephants weighing more than 1000 pounds, and configuration server 210 transmits information indicating that the web service is located on composition service server 220. In that example, “African,” “elephant,” and “1000 pounds” represent parameters for the web service to process. Upon receiving rendering server 206's request, configuration server 210 sends the corresponding web service parameter and location information back (212) to rendering server 206.

In an embodiment, rendering server 206 may also request a web service's configuration information. In an embodiment, configuration information comprises the hardware and software arrangements that define a server or web service. For example, information may include the specific language a web service is written in, capacity of a server's hard drive, processor specifications, operating system information, networking parameters, interfacing parameters, server locations, web service parameters, web service locations, composition service server locations, cache invalidation messages, or other system information.

For example, suppose user 202 requested a web page that displays the weather for a specific zip code. In this example, the zip code is a parameter for a web service that provides location specific weather, however, embodiments of the present invention are not limited to any particular parameters. To display the weather for zip code 98052, rendering server 206 would first see if the weather for that zip code was stored in its cache. If not, rendering server 206 requests that configuration server 210 send the location of a web service that could provide the weather for parameter 98052. Configuration server 210 would then inform rendering server 206 where to call a weather web service that would provide weather for the 98052 zip code. In another example, a casino security system comparing guest and player names with names used by cheaters is run online from an access restricted web page. Web service parameters would include names, physical characteristics, betting styles, and other traits distinguishing cheaters. If rendering server 206 requested a check on guest John Smith, configuration server 210 would use the parameter information to locate an appropriate web service on composition service server 220 and transmit the appropriate configuration and location information back to rendering server 206. Rendering server 206 would then request John Smith's background check from composition service server 220 by sending his specific traits. Rendering server 206 would cache the return of whether John Smith was a cheater for later fetches and display that result on the web page.

In an embodiment of the present invention, configuration server 210 is a server that centrally stores configuration, parameter, and location information for rendering servers, composition service servers, and web services. Configuration server 210 centrally manages the multi-tiered web page rendering system by fulfilling rendering server 206's web service requests and maintaining a list of composition service server 220's web service parameters and locations. Configuration server 210 also provides a directory which includes all web services parameters and locations. Furthermore, configuration server 210 receives updates regarding web services parameters and locations, rendering server locations and configuration information, and composition service server locations and configuration information.

Upon receipt of the web service location and parameter information, in an embodiment, rendering server 206 determines if the response of the web service is located in rendering server 206's cache (214). If so, rendering server 206 uses the cached response to render the content to the web page (216). However, if a web service's response is not stored in rendering server 206's cache, rendering server 206 uses the location and parameter information to remotely call, via a remote control (discussed below), a web service from composition service server 220. Composition service server 220 returns the appropriate web service response (222). Then, rendering server 206 stores the returned web service response in rendering server 206's cache (224) to be reused for future requests. In an embodiment, rendering server 206 stores the returned response with a cache key comprised of the parameters used to call the web service. Caching the web service response allows rendering server 206 to subsequently access the web service response much quicker than recalling composition service server 220. Rendering server 206 uses the newly cached web service response to render content on a web page to user 202 (226). Once all controls and web service responses are processed, the web page can be displayed to user 202.

In an embodiment, composition service server 220 stores web services and is in connection with configuration server 210. Composition service server 220 transmits server configuration, server location, web service parameter, and web service location information to configuration server 210. In addition, composition service server 220 updates such information whenever it changes. Composition service server 220 receives web service requests from rendering server 206, then returns results based on received web service parameters. In an embodiment, composition service server 220 may comprise multiple composition service servers all of which provide the aforementioned information to configuration server 210.

In an embodiment, rendering server 206 uses a remote control to call the web service (218) from composition service server 220. In an embodiment, the remote control is a routine, subroutine, function, set of functions, ASP.NET server control, or any piece of code executed by one computer or server to access a web service from another computer or server. For example, rendering server 206 may transmit a remote control consisting of the tag attribute “ServiceName” to composition service server 220 to access a web service. In an embodiment, the remote control allows rendering server 206 to be run within an ASP.NET web page. However, embodiments of the present invention are not limited thereto, as any number of additional tag attributes can be passed as required to access web services.

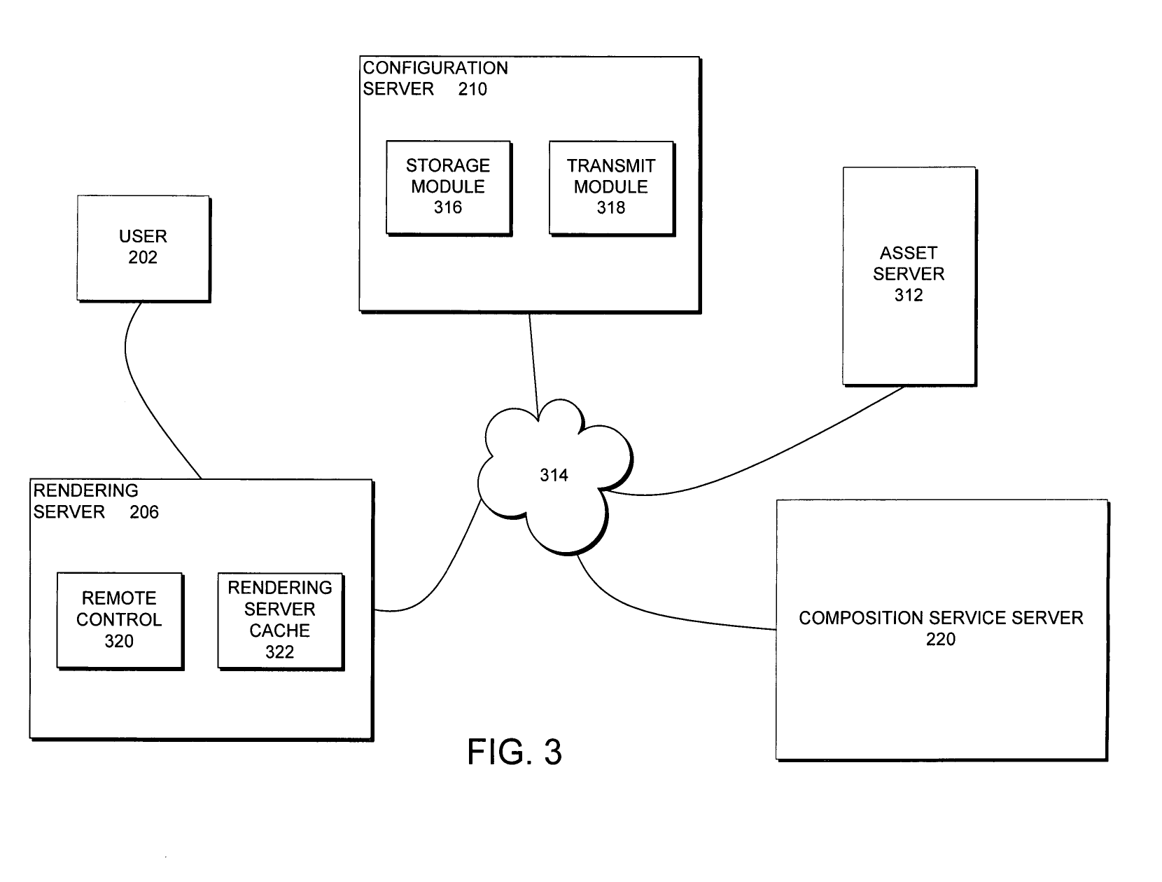

FIG. 3 is a block diagram of a multi-tiered system for rendering web pages, according to embodiments of the present invention. As illustrated in FIG. 3, the system comprises user 202, configuration server 210, asset server 312, composition service server 220, rendering server 206, and network connection 314. In an embodiment, rendering server 206 comprises remote control 320 and rendering server cache 322. In an embodiment, configuration server 210 comprises storage module 316 and transmit module 318. Configuration server 210, rendering server 206, composition service server 220, and asset server 312 are all connected via connection 314. In an embodiment, connection 314 comprises a LAN, WAN, or other network connection. However, embodiments are not limited to a specific network connection, as any may be used.

In an embodiment, configuration server 210 transmits a cache invalidation message to rendering server 206. Cache invalidation messages inform rendering server 206 to clear cached responses for specific web services. In essence, cache invalidation messages alert rendering server 206 of any updates to web services that could make old cached responses invalid. In an embodiment, rendering server 206 retrieves cache invalidation messages by polling configuration server 210. In another embodiment, configuration server 210 broadcasts cache invalidation messages to registered servers. In an embodiment, configuration server 210 receives cache invalidation messages from composition service server 220. For example, in a scenario where the web service was a news service, a web page might be configured to cache the news feed for ten minutes. If a late-breaking story was occurring, the news service (stored in composition service server 220) could notify configuration server 210 that cached news needs to be updated earlier. As a result, configuration server 210 could release a cache invalidation message to rendering server 206, informing it to clear its cache and call the news service. Accordingly, rendering server 206 would dump its cache, call the service, cache the response, and display the late-breaking story. In essence, this ensures that rendering server 206's cache is up-to-date.

In an embodiment, storage module 316 is any well-known storage medium that stores web service parameters, web service locations, web service configuration information, composition service server locations, composition service server configuration information, rendering server locations, or rendering server configuration information. In an embodiment, storage module 316 updates any of the stored information upon notification from rendering server 206 or composition service server 220. In an embodiment, transmit module 318 receives a request for any of the information and transmits information to requesting servers, computers, or network devices.

In an embodiment, remote control 320 allows rendering server 206 to request web services from composition service server 220. As discussed previously, remote control 320 may be a routine, subroutine, function, set of functions, or any piece of code executed by rendering server 206 to access a web service from another computer or server. In an embodiment, rendering server cache 322 is cached memory used by rendering server 206 to store information for web page building. In an embodiment, rendering server cache 322 comprises any high-speed storage mechanism as either a reserved section of main memory or an independent store. For example, in an embodiment, rendering server cache 322 uses memory caching, disk caching, or other caching systems.

Asset server 312 stores files that need to be accessed by composition service server 220. In other words, asset server 312 is a file storage solution and, in an embodiment, is a separate server from which composition service server 220 can retrieve files. In an embodiment, asset server 312 comprises a file server, a database server, an Internet resource, or other storage medium. However, embodiments of the present invention are not so limited, as asset server 312 may be any server solution. In an embodiment, asset server 312 may not be required, e.g., if a site or publishing tool already stores files in an accessible place to the system, e.g., locally. Further, embodiments of the present invention are not limited to one asset server 312, as any number may be used, or none at all.

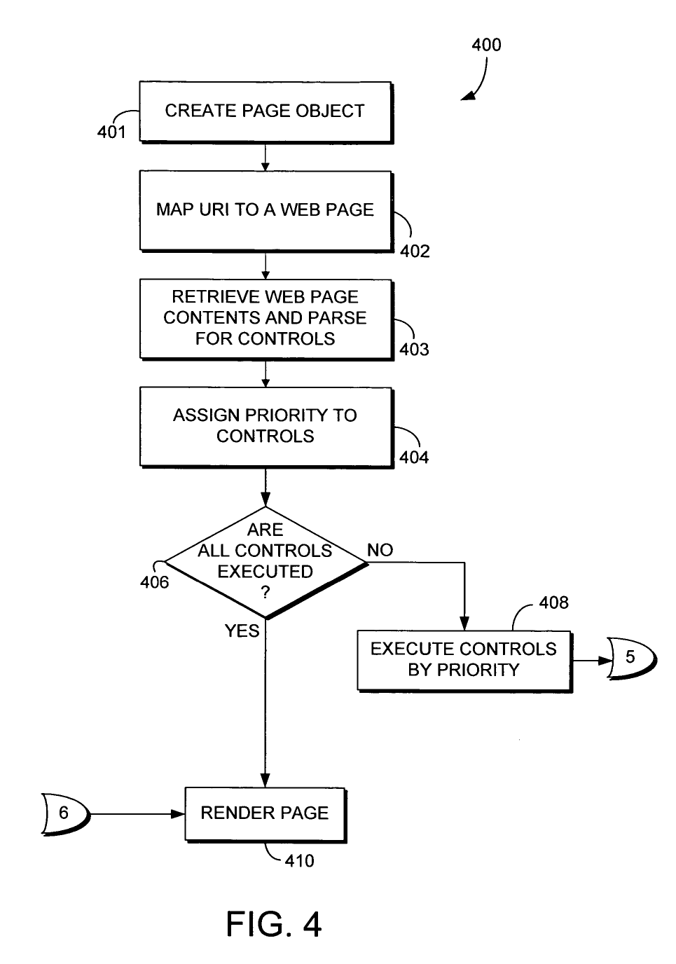

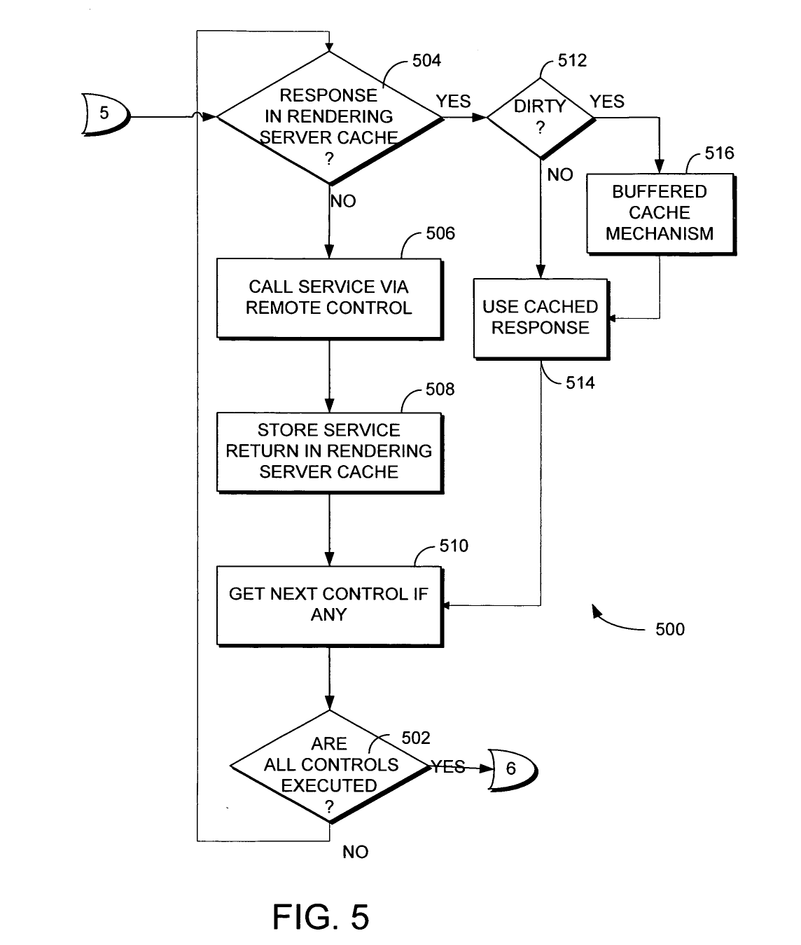

FIG. 4 is a flowchart illustrating a process for rendering a web page, according to embodiments of the present invention. Method 400 illustrates a process for rendering a web page. Initially, a page object is created (401). Next, the requested uniform resource identifier (URI) is mapped to a web page (402). The page's contents are retrieved and parsed for controls (403). Controls are then assigned priority for execution (404). In an embodiment, priority can be determined using a pipeline method implemented as phases. After priority is assigned, in an embodiment, it is determined whether all controls have been executed (406). If so, the page can be rendered (410). If controls to be executed remain, they are executed in order of priority (408). FIG. 5, accessed by jump 5, depicts the control execution process. After each control is executed in FIG. 5, it is again determined whether any other controls still need to be executed (502). Once all controls have been executed, the web page is rendered (410).

FIG. 5 is a flowchart illustrating web service caching, according to embodiments of the present invention. Method 500 illustrates control execution. When controls are identified, it is determined whether the highest priority control and its corresponding web service response is located in the rendering server's cache (504). If not, a web service is called via a remote control, using web service parameter and location information (506). The web service response that is returned is stored in the rendering server's cache (508). Subsequently, the next highest priority control is retrieved, (510).

If it is determined that the control and its corresponding web service response is cached (504), it is next determined whether the cached control has been stored there for a configurable amount of time (512). For purposes of the present invention, the configurable amount of time is herein referred to as “stale time.” In various embodiments, any configurable amount of time determined can be considered the stale time. Further, the stale time may vary between different types of data, cache, controls, or other variables. In an embodiment, the cached content may present some indicia that it has been stored longer than the stale time. For example, in an embodiment, cache content may be marked as “dirty,” “stale,” or with some other indication. If the control has not been cached for longer than the stale time, the cached response is used to render the web page (514), and the next highest priority control is processed (510). However, if the previous control has been cached for longer than the stale time, cache buffering is initiated (516), the cached response is used to render the web page (514), and the next highest priority control is processed (510). As indicated by jump 6 in FIG. 5, once all controls have been executed (502), the rendering server can render the page (410).

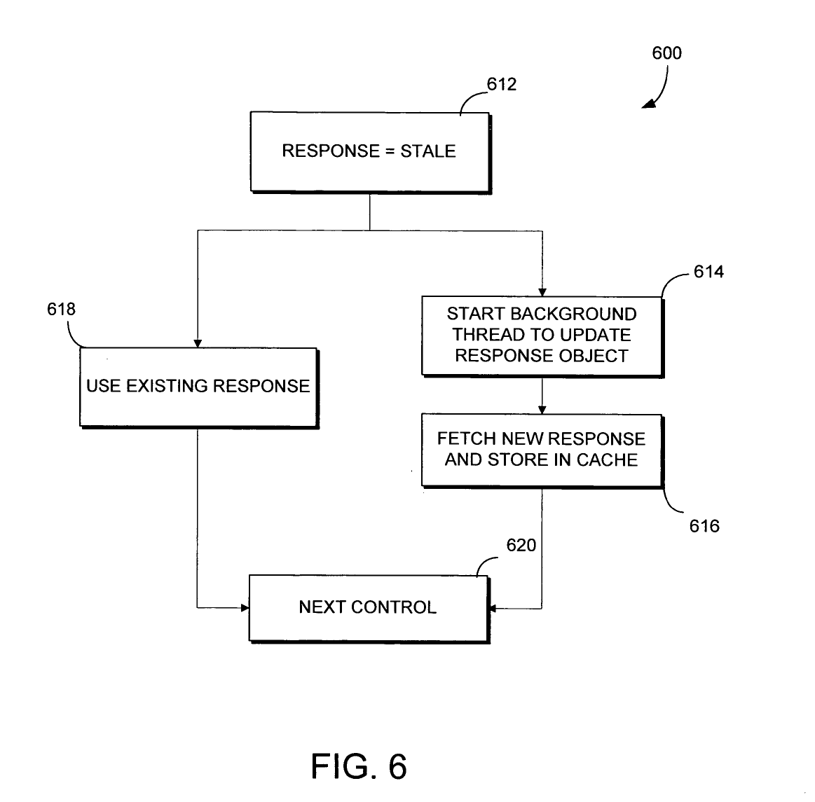

FIG. 6 is a flowchart illustrating cache buffering, according to embodiments of the present invention. Cache buffering handles data that has been stored on the rendering server cache longer than the stale time. Further, cache buffering is only used if a control's response has already been stored in the rendering server's cache and marked to show it has been there longer than the stale time. FIG. 6 begins with the response being marked as “stale” (612), which in an embodiment denotes storage for longer than the stale time. In embodiments, for stale responses, the rendering server uses the cached content to render the web page (618). In an embodiment, the rendering server then contemporaneously spawns a background thread (discussed below) (614) to get a new response and stores the new response in the rendering server cache (616). Subsequent retrievals from the rendering server cache will then return the new response instead of the old response. Although illustrated as being performed contemporaneously, in another embodiment, the rendering server spawns the background thread after the previously cached response has been used.

In an embodiment, a background thread is a type of object within a process that runs program instructions. Using multiple threads allows concurrent operations within a process and enables one process to run different parts of its program simultaneously. For example, a rendering server may process a Get(control_response) that retrieves a specific control response from the rendering server's cache. At the same time, a background thread may be used to fetch a new control_response to store in the rendering server cache. However, embodiments of the present invention are not limited to any particular background thread.

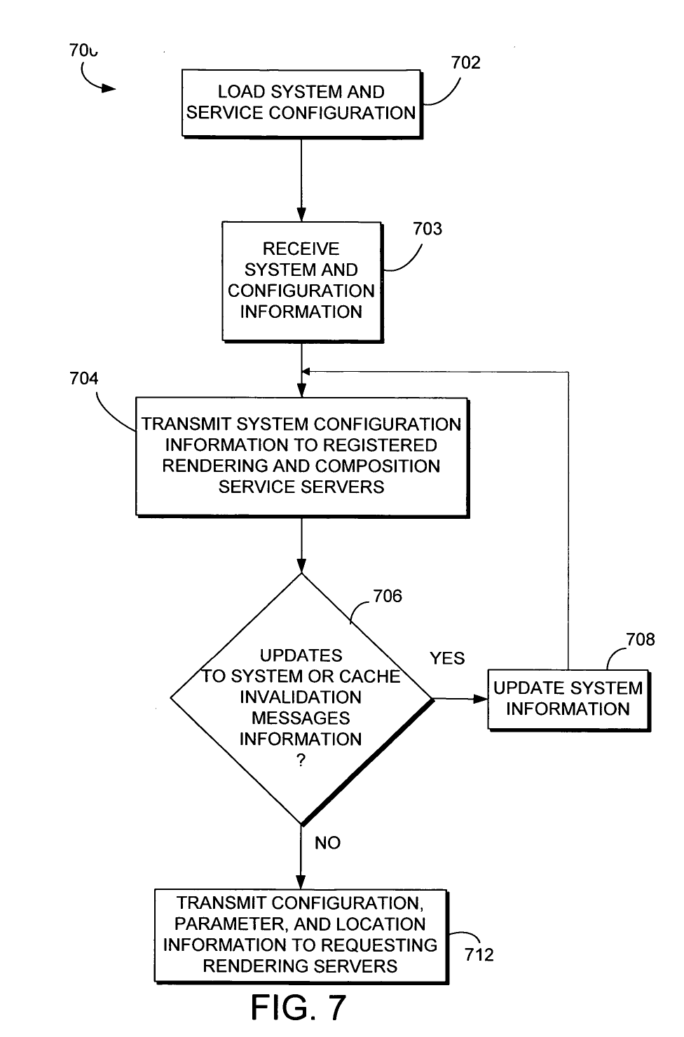

FIG. 7 is a flowchart illustrating the management of updates, according to embodiments of the present invention. As illustrated in FIG. 7, method 700 begins with the system and service configuration information being loaded (702), allowing servers to register for service configuration and cache invalidation messages. In an embodiment, system and service configuration information comprises the hardware and software arrangements that define a server or web service. For example, system and service configuration information may include the specific language a web service is written in, capacity of a server's hard drive, processor specifications, operating system information, networking parameters, interfacing parameters, server locations, web service parameters, web service locations, composition service server locations, cache invalidation messages, or other system information. In an embodiment, rendering and composition service servers register by making a web service call. Once the system and configuration information is received (703), it is transmitted to registered rendering and composition service servers (704).

The system and configuration information is monitored for updates. For example, web service parameters, web service locations, rendering server locations, rendering server configuration information, composition service server locations, composition service server configuration information, cache invalidation messages, and other data necessary to web page rendering may be updated. If updates occur (706), system information is updated (708) and the updated information is retransmitted to registered rendering and composition service servers (704). In an embodiment, servers poll for configuration updates. In another embodiment, configuration updates are broadcast to registered servers. However, if no updates exist (706), the requested configuration, parameter, and location information is transmitted to rendering servers and composition service servers (712).

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The invention claimed is:

1. A system for assembling pages from content retrieved by content service calls, comprising:
at least one rendering server to assemble a page from a plurality of fragments;
at least one composition service server to store at least one composition service that returns at least one of the plurality of fragments; and
a configuration server to store configuration, location, and parameter information about the at least one rendering server or the at least one composition service server and to provide the configuration, location, or parameter information to the at least one rendering server or the at least one composition service server.

2. The system of claim 1, further comprising a central store to store files for access by the at least one composition service server.

3. The system of claim 1, wherein the configuration server provides the configuration, parameter, or location information to the at least one rendering server or the at least one composition service server.

4. The system of claim 1,
wherein the at least one rendering server is a plurality of rendering servers that are identically configured, and
wherein the at least one composition service server is a plurality of composition service servers that are separate from each other.

5. The system of claim 1, wherein the configuration server provides parameter, configuration, and location information about the at least one rendering server and the at least one composition service server to the at least one rendering server and the at least one composition service server.

6. The system of claim 1, wherein the at least one rendering server stores at least one of the plurality of fragments in a rendering server cache.

7. The system of claim 6, wherein the configuration server sends a cache invalidation message to the at least one rendering server.

8. The system of claim 6, further comprising:
a buffered cache mechanism to return, as one of the plurality of fragments, information stored in the rendering server cache that has been stored longer than a configurable amount of time while a background thread located on the rendering server retrieves and inserts a new response into the rendering server cache.

9. The system of claim 1, wherein the at least one rendering server clears information stored in the rendering server cache upon receipt of the cache invalidation message.

10. The system of claim 1, wherein the at least one rendering service server and the at least one composition service server are configured by accessing the configuration server.

11. The system of claim 1, further comprising a remote control used by the at least one rendering server to call the at least one composition service from the at least one composition service server.

12. The system of claim 1, wherein the at least one composition service server is remote from the at least one rendering server.

13. A method, comprising:
receiving a request from a user to render a web page, wherein the web page incorporates a web service;
determining whether a web service data structure is stored in a rendering server cache;
if the rendering server cache does not contain the web service data structure, requesting the web service data structure from a composition service server and storing the web service data structure in the rendering server cache; and
rendering the web page using the web service data structure that is stored in the rendering server cache.

14. The method of claim 13, further comprising:
if the web service data structure has been stored in the rendering server cache for a configurable period of time, labeling the rendering server cache as having stale content.

15. The method of claim 14, further comprising:
retaining the web service data structure stored in the rendering server cache that has been labeled stale until a web service request is made for the data structure;
rendering a web page using the stale web service data structure;
clearing the rendering server cache;
calling a new web service; and
storing a new data structure returned from the new web service in the rendering server cache.

16. A configuration server, comprising:
a storage module to store configuration, location, and parameter information about at least one rendering server or at least one composition service server; and
a transmit module to provide the configuration, location, or parameter information to the at least one rendering server or the at least one composition service server,
wherein the at least one rendering server assembles a page, and
wherein the at least one composition service server stores a composition service.

17. The configuration server of claim 16, wherein the storage module receives updates of composition service parameters, composition service locations, the at least one rendering server's location, or the at least one composition service server's location.

18. The configuration server of claim 16, wherein the storage module is a central store for all configuration, parameter, and location information for the at least one rendering server and the at least one composition service server.

19. The configuration server of claim 16, wherein the storage module receives configuration information regarding the at least one rendering server or the at least one composition service server.

20. The configuration server of claim 16,
wherein the transmit module provides the configuration, parameter, or location information to the at least one rendering server or the at least one composition service server.
